(19) United States
(12) Patent Application Publication
(10) Pub. No.: US 2018/0060901 A1
(43) Pub. Date: Mar. 1, 2018

(54) Networked System and Method for Increasing Brand Awareness and Data Collection Using Gamification

(71) Applicant: Perry Lyndon-James, Claremond (AU)

(72) Inventor: Perry Lyndon-James, Claremond (AU)

(21) Appl. No.: 15/677,216

(22) Filed: Aug. 15, 2017

Related U.S. Application Data
(60) Provisional application No. 62/375,366, filed on Aug. 15, 2016.

(51) Int. Cl. G06Q 30/02; G06Q 50/00; G06N 3/08

(52) U.S. Cl. CPC G06Q 30/0242; G06N 3/08; G06Q 30/0209; G06Q 50/01

(57) ABSTRACT

A system embodied on a computer readable storage medium enhancing brand awareness, collecting data, or both is provided. The system has a content management system (CMS) in communication with a memory and configured to identify a brand of a plurality of brands and manage generated content, a task engine in communication with the CMS, the task engine configured to generate content, wherein the content comprises a plurality of gamified advertisements that are correlated to the brand, wherein a user interacts directly with the gamified advertisements, an action engine in communication with the task engine and configured to monitor user action and behavior, capture analytics as outputs, or both, and a rewards module in communication with the memory and configured to track user rewards based on achievement in the plurality of gamified advertisements correlated to the plurality of brands. A method for enhancing brand awareness and collecting data is further provided.

### CROSS REFERENCE TO RELATED APPLICATION

This application claims the benefit of U.S. Provisional Application No. 62375366, entitled A Networked System and Method for Optimizing User Retention, filed on Aug. 15, 2016.

### FIELD OF THE INVENTION

The present invention relates generally to networked and web-based computer platforms, contests and social games. More particularly, the invention relates to the quantitative processing directed towards user games, tasks, contests and competitions for which prizes and/or rewards are distributed to users on the network, while optimizing networked games in terms of speed, communication and user retention.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND OF THE INVENTION

The development of the Internet and wireless protocol has led to a vast increase in human interaction via social networking, online gaming and other networked mobile applications and computer platforms. This has allowed people (also referred to herein as “users”) in various parts of the world to communicate and interact on various gaming levels, and has given advertisers a new platform to glean consumer attention from. Wireless protocol, and in particular mobile application development has led to a new market of goods and services not realized prior to the development of large scale networking and mobile devices (e.g., smartphone), which can be easily procured on mobile application distribution platforms such as the Apple App Store, Google Play, Windows Phone Store and BlackBerry App World.

As a consequence, millions of users are able to participate in games, contest, competitions and bid-type interactive buying from the comfort of their own homes. These networked skill-based games and competitions are played by millions of users. As an example of the popularity of networked based skill-based games, it is estimated that over 1.2 billion people play online social games, 41 million people played online fantasy football in 2013 and 15 million played online poker. It is further estimated that people spend 3 billion hours per week playing games, with at least half of those hours spent on a smartphone.

The internet (e.g., networked interactions) has also led to an increased ability to perform enhanced market and product research, due to an exponential increase in audience, or “sample size”. Having the facility to reach out to millions of consumers (referred to herein as “users”) with such relative ease has, not surprisingly, transformed the market research industry, and by proxy, the advertising industry. Each of these two industries are multi-billion dollar industries, the former providing invaluable information and the latter relying on this information to increase market share. However, each relies specifically on two critical aspects; gathering valuable information from the consumer in the most accurate and efficient way possible, and using this information correctly to increase the merchants market share.

This concept has led to an increase in operator run platforms that offer prizes and rewards. As an example, a “reward website”, as defined herein, is a website which requires a user to perform a set of tasks, and upon completion of these tasks, the user receives a reward, typically in the form of points which can be remitted for items of value. The operators of these websites may “sell” information to merchants in the form of analytical data, or work directly with merchants to set up advertising campaigns to increase product or brand visibility. Again, because analytics are more dependable and accurate based on sample size, user retention and user acquisition rates are extremely important aspect of these websites. In other words, the more users the website or application has and the longer those users are active on the website or application, means the higher the value proposition to the advertiser or merchant, and thus the value for the operator increases.

However, the problem with these platforms is that they're notoriously dull, and thus, have low user retention rates. Many times, users must fill out very long surveys, or participate in lengthy programs that last thirty days or more, just to earn the reward. Furthermore, and most importantly, they lack the social aspects popular with users. Consequently, the ad-hoc approaches that exist today do not capture the user's attention in a way that optimizes value for the operator, user and merchant. In other words, many of the approaches that exist today simply do not resonate with users at the point of impression, which results in a decreased value to each of the operator, user and merchant.

Concurrently, advertisers have ramped up the “targeted interruption” advertising model and ecosystem. Targeted interruption advertising occurs at almost every level when there is consumption of media (e.g., videos, social media platforms and the like). These ads have become an uncompromising annoyance to the consumer, which has led to these ads having a lasting negative impact. Furthermore, the consumer has become much more likely to employ and ad-blocking solution to block the ads entirely. There has been a clear trend in the industry that if the ads don't have a clear value exchange, the consumer will block them altogether.

Accordingly, there is a need for an improved system and method for enhancing brand awareness and collecting data that obviates the above-described problems.

### BRIEF DESCRIPTION OF THE DRAWINGS

The present invention is illustrated by way of example, and not by way of limitation, in the figures of the accompanying drawings and in which like reference numerals refer to similar elements. Features of the present disclosure, its nature and various advantages will be more apparent upon consideration of the following detailed description, taken in conjunction with the accompanying drawings in which:

FIG. 1 is a block diagram depicting a networked system which may be used by an exemplary mobile or web-enabled embodiment of the present invention;

FIG. 2 is a block diagram of an exemplary hardware architecture and firmware framework in accordance with embodiments of the present invention;

FIG. 3 client side/server side flow chart in accordance with embodiments of the present invention;

FIG. 4 is a block diagram illustrating a system for communication between the platform and a partner site in accordance with embodiments of the present invention;

FIG. 5 is a flow chart illustrating a step-wise method for a merchant to build a campaign in accordance with embodiments of the present invention;

FIG. 6 is a block diagram illustrating a system for market research firms to gather data in accordance with embodiments of the present invention;

FIG. 7 is block diagram illustrating a rewards program in accordance with embodiments of the present invention;

FIG. 8 illustrates exemplary interactive elements and graphical user interfaces in accordance with embodiments of the present invention;

FIG. 9 illustrates exemplary interactive elements and graphical user interfaces in accordance with embodiments of the present invention; and

FIG. 10 illustrates exemplary interactive elements and graphical user interfaces in accordance with embodiments of the present invention;

FIG. 11 is block diagram illustrating a rewards program in accordance with embodiments of the present invention.

FIG. 12 is a block diagram illustrating a networked system in accordance with embodiments of the present invention;

FIG. 13 is a block diagram illustrating the platform integrated with a partner system accordance with embodiments of the present invention;

FIG. 14 is a block diagram showing the system of FIG. 12 in communication with an ad network or exchange; and

FIG. 15 a block diagram flow chart showing the flow of the system in accordance with embodiments of the present invention.

Unless otherwise indicated illustrations in the figures are not necessarily drawn to scale.

### SUMMARY OF THE INVENTION

To achieve the forgoing and other aspects and in accordance with the purpose of the invention, a method, system and computer program product for increasing value to a user, operator and merchant is described herein.

In an embodiment of the present invention, a system embodied on a computer readable storage medium for enhancing brand awareness, collecting data, or both. The system comprises a content management system (CMS) in communication with a memory and configured to identify a brand of a plurality of brands and manage generated content; a task engine in communication with the CMS, the task engine configured to generate content, wherein the content comprises a plurality of gamified advertisements that are correlated to the brand, wherein a user interacts directly with the gamified advertisements; an action engine in communication with the task engine and configured to monitor user action and behavior, capture analytics as outputs, or both; and a rewards module in communication with the memory and configured to track user rewards based on achievement in the plurality of gamified advertisements correlated to the plurality of brands. In this embodiment, the system may employ machine learning to adjust eth gamified ads the users will interact with.

In an embodiment of the present invention, a system embodied on a computer readable storage medium for providing an interactive user experience configured to optimize brand awareness collect data, or both is provided. The system comprises a content management system (CMS) in communication with a memory and configured to receive media from an content creator; a task engine configured to retrieve the media, the media being selectable and correlated to a brand; wherein the task engine is further configured to communicate with an agency trading desk (ATD) and a demand-side platform (DSP) to manage and optimize the media, wherein the media is a gamified ad campaigns, and wherein the media is retrievable by the ATD and DSP.

In an embodiment of the present invention, a computer implemented method for enhancing brand awareness, collecting data, or both, is provided. The method comprises generating a plurality of tasks correlated to a plurality of brands, wherein the tasks are gamified advertisements; receiving, from a client device, an input requesting to perform a task of the plurality of tasks; displaying, on the client device, the requested task; receiving outputs from the client device at the server, wherein the outputs are a user action; capturing the actions and converting the actions into analytics.tracking user rewards based on the actions in the plurality of gamified advertisements correlated to the plurality of brands.

Advantages of the present invention over the prior art are numerous, including, but not limited to, increase in overall user engagement completion rate, average session duration, average number of completed engagement (i.e., task or gamified ads), number of verified branded scree views per use and average verified engagement time with branded content (gamified ad).

The present invention also allows a merchant to find and pinpoint weaknesses in its existing marketing and communication strategies, and improves brand and product knowledge through engagement. It also allows merchants to uncover hidden strategic opportunities, because as data is revealed in the course of a campaign, the information gained can be used to justify continued support of successful communications strategies, correct unsuccessful ones or potentially create wholly new strategies based on user response data. Indeed, the inventors have shown based on testing a net lift of seventeen percent in brand and product knowledge based on engagement with an interactive game or task.

Through the combination of interactive brand engagement, entertainment/gamification, consumer feedback and market research the platform enables merchants and market researches to glean information from the user where it has not been conventionally done in the context of branded advertising.

Other features, advantages, and aspects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

While exemplary embodiments of the present invention will be described with reference to certain types of mobile applications, a skilled artisan will realize that embodiments of the invention are applicable to any type of mobile application and/or web module in which quantitative analyses on user value is beneficial.

As used herein, a “gamified advertisement” or “gamification” refers to the application of game-design elements and game principles in non-game contexts to improve user brand engagement, brand knowledge, and the like.

As used herein, a “merchant” is an organization using the multi-tenant platform to drive advertising and revenue, and may be the recipient of certain market and/or product research driven by the platform and its operators. The merchant may ultimately sell and/or offer goods and services to end users through the system and method described herein. The merchant's staff administers may interface directly with the platform, in some embodiments.

As used herein, an “operator” is the organization or person who owns, or is in control of, the platform. The operator may, in some embodiments, set contests or competitions, award prizes, gather data, sell data and the like. In some cases, the operator may also be the merchant or representing the merchant's interests as they relate to the platform.

As used herein, a “task” represents an opportunity for a user to perform a certain undertaking to earn a reward. The undertaking, in some embodiments, may represent playing a game, gamified advertisement, completing a survey, providing a review, taking a quiz, watching and/or submitting a video “sharing,” “liking,” or “following” something on social media. It may further represent an objective game or a subjective sweepstakes. It may also include the use of physical/geospatial tasks such as walking to a particular location so that content related to the brand may appear (virtually) in the user's device as part of a scavenger hunt-type game manifestation. In this type of task, the section parameters may include trivia, direct response, stimuli and timing completions. These comprise mobile-enabled physical game play tasks such as puzzle solving. These types of tasks can be used to direct foot traffic to brick and mortar establishments and other branded events.

As used herein, a “client” represents a user device that may be used as a platform for audio-visual media including games, mobile applications, books, movies, music and web content. In the current embodiment, the clients are smart phones. In other embodiments, however, a client may also include personal digital assistants, tablet devices, e-readers, wireless music devices and any other personal computing device such as desktops and laptops, which includes at least one of a display, processor, memory or input or output means.

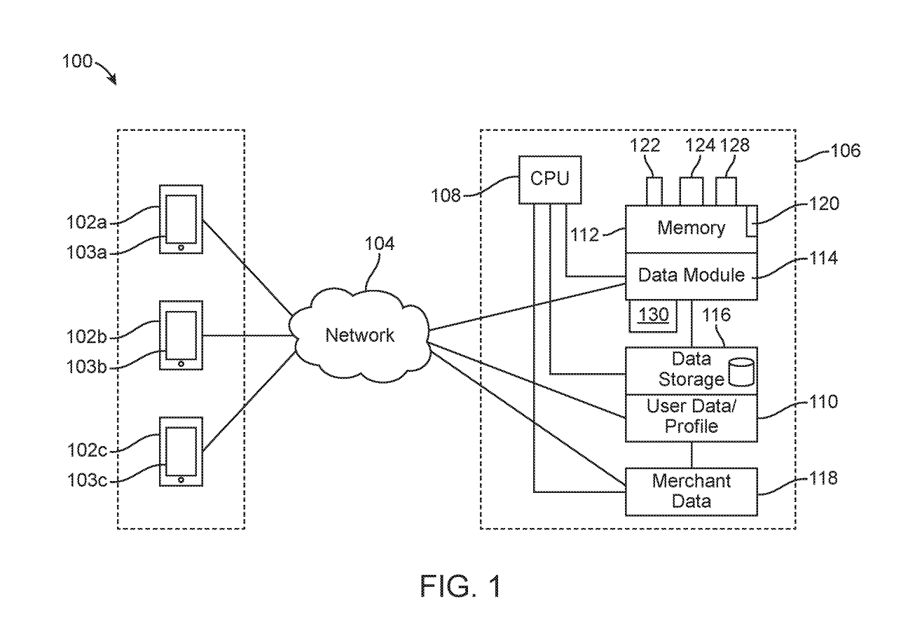

The exemplary embodiments of the present invention is to be described in greater detail in relation to FIGS. 1-15.

A first embodiment of the present invention will be described which provides means and methods for increasing user-retention and accuracy of game measurement categories during an online gaming experience or task competition.

Referring now to FIG. 1, a block diagram depicting an exemplary networked system which may be used together with an exemplary embodiment of the present invention is shown generally at 100.

Still referring to FIG. 1, Clients 102a, 102b and 102c (n+1) are shown at which one or more independent users may participate in a task. However, it should be noted that while only three clients 102a, 102b and 102c are shown, the present methods and systems are applicable to large volume networks in the order of hundreds of thousands or millions of clients (n+1).

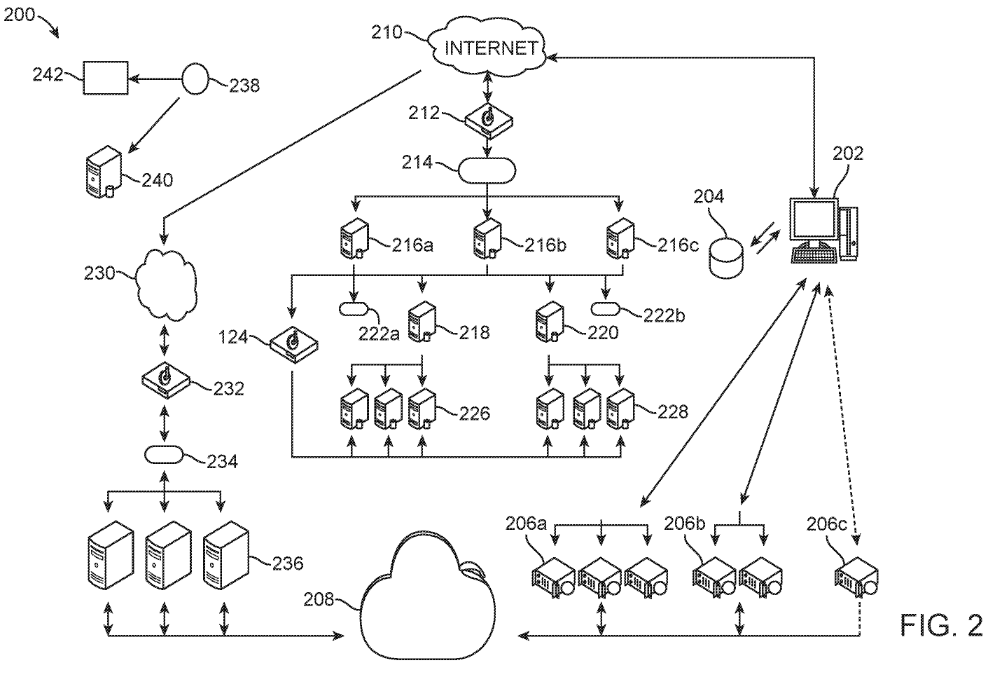

The clients 102a, 102b and 102c, in one embodiment of the present invention, may be communicatively connected to each other, and further communicably connected to at least a server 106 via network 104. The server 106 may be in further communication with a central processing unit (CPU) 108 and a data module 110, which will be discussed in further detail with relation to FIG. 2.

Clients 102a, 102b and 102c, which in this exemplary embodiment are smart phones, may comprise various known hardware, software and firmware. For example, the smart phones may comprise a CPU, a sensory representation (a visual, auditory, or tactile output such as a graphic display, a tone or a vibration), a Graphical User Interface (GUI), having a keyboard/touchpad, a microphone, a memory, a mass memory storage, a graphical user interface, a video camera, an input/output interface and a network interface. The client may also include removable media devices (e.g., memory cards, etc.).

In this exemplary embodiment of the present invention, client 102a may communicate bi-directionally with the server 106 through network 104. The network 104 may comprise the Internet, local area networks (LANs), wide area networks (WANs), wired telephone networks, wireless networks or any other network supporting data communication between respective clients, developers, servers and the like.

The server 106 may comprise a single CPU or multiple CPUs and may include micro-controllers (e.g., with embedded RAM/ROM) and microprocessors such as programmable devices (e.g., RISC or CISC based, or CPLDs and FPGAs) and devices not capable of being programmed such as gate array ASICs (Application Specific Integrated Circuits) or general purpose microprocessors.

The server 106 comprises memory 112, which is used to transfer data and instructions to processor in a bi-directional manner. Memory 112, as discussed may include any suitable computer-readable media, intended for data storage, such as those described above excluding any wired or wireless transmissions unless specifically noted.

Memory 112 may include a memory module 114, which is configured as short term volatile memory for user memory in cache, and to communicate with mass data storage 116. Virtual storage or memory 120 may be further provided for increased speed and security for memory isolation, where needed.

Mass data storage 116 may also be coupled bi-directionally to the CPU 108 and provide additional data storage capacity and may include any of the computer-readable media described above. Mass data storage 116 may be used to store programs, data and the like and is typically a secondary storage medium such as a hard disk. It will be appreciated that the information retained within mass data storage 116, may, in appropriate cases, be incorporated in standard fashion as part of memory 112 as virtual memory.

In exemplary embodiments of the present invention, the mass data storage 116 may comprise data module 110 for storing, for example, user profiles. The data module 110 may also store, for example, user habits as well.

In exemplary embodiments, the server 106 further comprises user and/or merchant data, which comprises user and/or merchant ID and login information.

In exemplary embodiments of the present invention, the server 106 may also comprises task engine 122, action engine 124, content management system (CMS) 126, location module 128 and reporting engine 130.

Task engine 122 comprises tasks to be loaded by an operator, or in optional embodiments, to be loaded by a merchant. The task engine 122 is configured to set dates and times for tasks a user can opt in to. The tasks may be geo-specific, and thus, the task engine 122 may be in communication with the location module 128. For example, the task may be related to a local merchant, and thus, the task engine would not offer a task to a user in Los Angeles, California related to a merchant in Albany, New York. In this way, the task engine 122 is configured to toggle through tasks related to information received as an input from the location module 128, and tie those tasks to a user in a particular location.

Once a user opts in, they can choose from a plurality of tasks associated with a plurality of different brands. The user may opt-in to an objective competition in which the user participates against other users to win prize and/or loyalty reward points, or a sweepstakes to win a prize and/or reward points to be redeemed for goods or services, or a subjective opinion type task in which the user gives subjective feedback regarding the brand. The user may also be randomly awarded just for reviewing branded content for a required period of time or for physical/geospatial tasks such as walking to a particular location so that content related to the brand may appear (virtually) on the user's device as part of a scavenger hunt-type game manifestation. Finally, the user may be awarded a reward or prize for the successful referral of a new user.

Action engine 124 is in communication with memory 112. Action engine 124 is configured to monitor user action and behavior, capture analytics and send those analytics as outputs to the operator and/or the merchants. In this way, task popularity is known, and rewards can be adjusted accordingly by the operator or merchant. The action engine 124 can further use this data and compare it to key performance indicators to automatically make offers to user's based on the user's past performance and choices made on the platform itself in an attempt to maximize return on investment (ROI). In embodiments of the present invention, machine learning such as an artificial neural network (ANN) learning algorithm may be employed to model the complex relationships between the user inputs and data outputs, find patterns in data, or to capture the statistical structure in an unknown joint probability distribution between the observed variables, and thereby output. Other machine learning techniques such as random forest may be utilized as well.

CMS 126 is also in communication with memory 112. The CMS 126 is configured to store advertisements that are applied to tasks in embodiments of the present invention. Furthermore, the CMS 126 is configured to use user sign up data to offer tasks to users. For example, user data such as age, gender, likes, dislikes and similar data are used to choose which tasks a user may be offered. For example, a social game involving cartoon characters may be offered to a young child, whereas an adult would receive an adult-themed task. Likewise, the rewards that are offered are associated with user data. In operation, the system is configured as a thinking machine (e.g., deep neural network) to maximize user retention.

A dedicated reporting engine 130 is also in communication with memory 112, and is configured to output all data including user data, task data, advertising data, sales figures, and the like. This can be done on an automated basis for the merchants and the operators.

In exemplary embodiments of the present invention, the system or platform is downloadable onto clients 102a, 102b or 102 as a native mobile application. The platform may also be a progressive web application or be a publisher platform, each of which are discussed din greater detail with relation the FIGS. The network 104 may be a cloud, for example an IoS cloud or an Android cloud, each representing a marketplace of data in which to request and retrieve certain mobile applications. Other examples BlackBerry, HP webOS, Symbian OS, Bada and Windows Mobile.

Smartphones may communicate via remote connectivity including, but not limited to the Internet, satellite networks, cell phone networks, other wireless networks and standards such as 802.11, 80211.b, 802.11g, or similar wireless LAN operating standards, or Bluetooth technologies, infrared connections, or any other similar technologies or other technologies such as those described above that permit the sending and/or receiving and/or processing of electronic information in either an encrypted or unencrypted format.

Users through the use of the clients 102a, 102b and 102c may compete in various competitions and may complete various assigned tasks to earn reward points. In some embodiments, users, via clients 102a, 102b and 102c, may challenge each other in a head to head format in various games to earn points, and some instances, for which they can wager.

In embodiments of the present invention, points may accrue for engagement in current or previous competitions. Points have a variety of “uses” ranging from discount purchasing power on available items or deals within the platform, or, they can be used to ascertain a competitive advantage, such as a “hints” should the game be a trivia-type game. Points can also be used to access exclusive content and have a variety of other in-platform applications.

In these trivia-type challenges, in some embodiments in addition to competing with a plurality of other participants to associated users may be directly compared to determine the transfer of points. In other words, a game within a game can be played between users and participants. This resulting gamification based on brand awareness further heightens brand awareness for the merchant.

Users may earn points for engagement activity within the competitions, and for social activity that promotes the application or platform, such as for example, referring a friend sharing the competition with a friend. Points may have a variety of uses ranging from discount purchasing power on available items or to gain an advantage in another game. As an example a user may use points to unlock a hint that is a reveal of peripheral information that pertains to upcoming competitions. They can use points to enable the enhanced performance for competitions to then earn additional points. Points can also be used to access exclusive content and have a variety of other in-platform applications.

In optional embodiments of the present invention, users may earn points in other noncompetitive ways. Noncompeting examples include referrals and wildcards or random draws. Referral winners may be selected randomly, with the more people being referred by user, the more potential for that user to win. An exemplary process for a referral system is as follows:

Each existing user has a unique referral code (User A). On any given day, up to 3 new users (User's B, C, D) can use User A′s referral code to gain entry to the referral draw (the specifics can be edited on the backend/admin side of the application). Upon entering User A's referral code, the system recognizes User B, C or D's referrals to have come from User A and subsequently also creates a new code for Users B, C and D. This new unique code for Users B, C and D should be the one that gets entered into the draw on their behalf. If the maximum (3) new users all use User A's referral code to enter the draw, User A should have 3 entries into the draw and the new users all have just 1 entry. If Users B, C or D wish to gain additional entries into the referral draw, then their unique code would need to be used by (up to) 3 new users that they in turn refer (reinitiating the process). Thus, the maximum number of entries into the referral draw that any user could have, under any circumstance, would be 4. A new user, using an existing user's referral code gets 1 entry and they subsequently refer 3 new users of their own.

A wildcard may include in exemplary embodiments a randomly selected winner for multiple randomly selected winners from the competition leaderboard. The prerequisite for appearing on the leaderboard may be that the user achieves the appropriate level of accuracy in a competition attempt.

Referring now to FIG. 2, a more detailed block diagram depicting an exemplary client/server system which may be used together with an exemplary embodiment of the present invention, which is shown generally at 200.

FIG. 2 shows a networked environment 200, including servers communicatively coupled to each other by one or more networks, for a social online marketplace, in accordance with an embodiment of the present invention. It should be noted that while desktop CPUs are shown herein, mobile devices may be used as well.

Networked environment 200 includes a user terminal 202, an upload traffic cop 204, an upload farm 206a, 206b and 206c, a commercial server 208, an internet 210, an elastic load balancer 212, a varnish pool 214, a web servers 216a, 216b and 216c, a photo MySQL master 218, a user MySQL master 220, a cache memory 222a, and 222b, an elastic load balancer 224, a slave MySQL 226, a slave MySQL 228, a content delivery network 230, an elastic load balancer 232, a varnish pool 234, an image server 236, a Command Run On 240, a Rabbit MQ 242, and a Mongo database 244.

User terminal 202 is a computer linked to an internet 210. In an embodiment or the present invention, there are multiple user terminals. Each of the user terminals is accessible to one or more independent users. Data from the user is stored in upload farms 206a, 206b and 206c. The upload farms 206a, 206b and 206c allow users to store and retrieve personal data.

During user tasks and competitions, tactile response (or responses generally) pass through elastic load balancer 212. The response goes to varnish pool 214 before reaching web servers 216a, 216b and 216c. The elastic load balancer 212 connects the users of the user with multiple web servers through the varnish pool 214 to automatically distribute the incoming traffic across the multiple web servers to increase speed and verification. The varnish pool 214 creates a cache of the content and passes it to the web servers 216a, 216b and 216c. The final product and winner may be stored and played on the Photo MySQL Master 218 and User MySQL Master 220, respectively. A cache of content is created through cache memory 222a and 222b. Cache memory 222a and 222b makes the retrieval of the data from the storage fast as it stores the previously retrieved data temporarily and prevents the system to look in the mass storage every time for retrieving the data. Each of the Photo MySQL Master 218 and User MySQL Master 220 further is connected to Slave MySQL 226 and Slave MySQL 228 respectively through Elastic Load Balancer 224. The Elastic Load Balancer 224 used in between the Photo MySQL Master 218, the User MySQL Master 220 and the Slave MySQL 226 and allows easy retrieval of data from the database as it distributes the commands for retrieving the data. Networked Environment 200 additionally includes Command Run On 240, Rabbit MQ 242 and Mongo database 244.

In games in which speed and tactile responses determine the winner, it is critical that responses be received as fast as possible to ensure absolute fairness. The system architecture in this embodiment speeds up the time it takes for servers to receive a valid response from user's who are in some instances across the globe. Additionally the time can be recorded on the device and uploaded to the server when internet access is available (provided it is within the available/contest period).

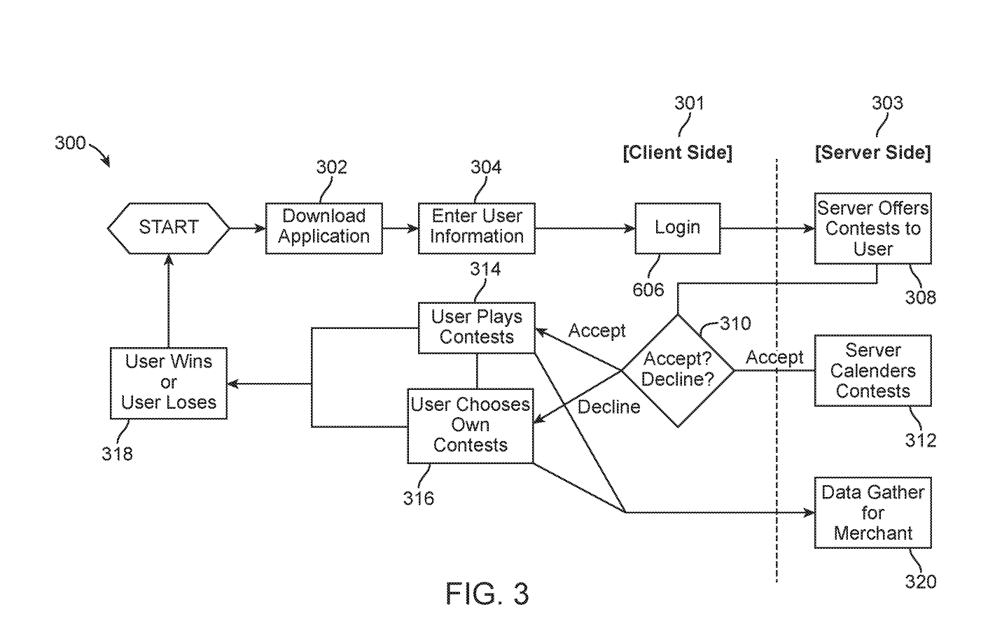

Referring now to FIG. 3, there is shown a flow chart having to further illustrate a method for social gaming, such one on a redemption website, at reference numeral 300. The method, executable by the platform described above with reference to FIG. 1 and FIG. 2, will be described with client side 301 and a server side 303.

At step 302, a user downloads the application on the user's client, which is a smart phone device in this exemplary embodiment. In operation, the user connects to an application store (e.g., Apple App Store, Android Market, MiKandi, Amazon App Store and BlackBerry App World), and the social gaming application is fully downloadable, and integratable into any type of client.

At step 304, the user may enter personal information in the dialog boxes. Personal information may include nickname, phone number, interests, likes, dislikes and other information such as an address or an opt-in to geo-location services. A user profile may also include the language spoken by a user, duration of time spent and frequency of time in the online environment, and duration of time spent within a sub location within the online environment.

At step 306, the user may log in to social application using a user name and password, for example.

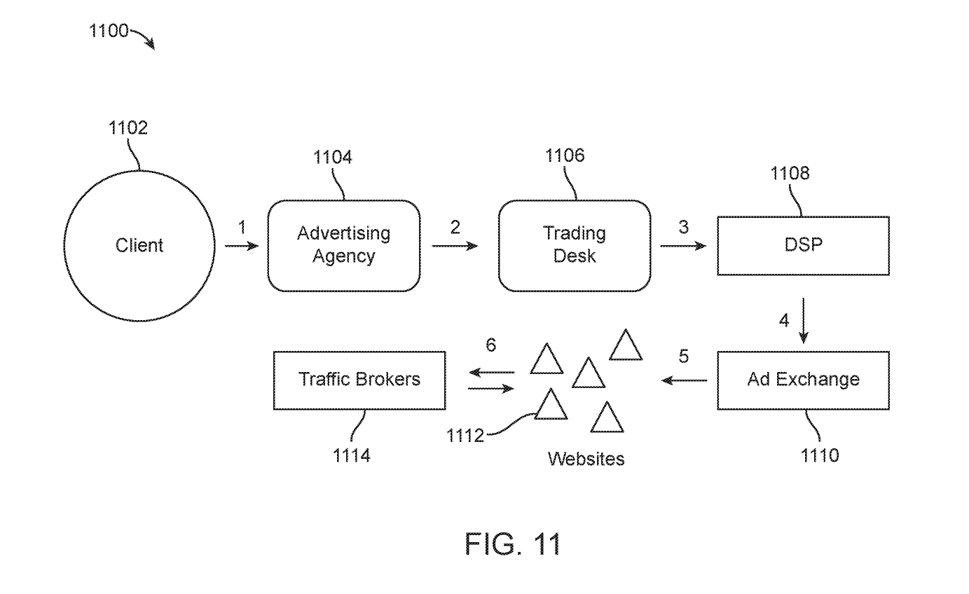

At step 308, the server is configured to pull input data from step 306, and suggest contests so that a user will be with his or her peers, and immediately have prizes the user finds attractive, which increases user retention for the operator and advertiser. Further, as described in more detail with relation to FIG. 11, the server may in communication with advertising networks and exchanges. In some embodiments, an advertiser may manipulate their content on the platform directly, or the operator may do it on the merchant's behalf. their behalf. In other embodiments, the platform may be integrated with an ad network or ad-exchange, such that the content will pass through other external systems before being displayed on platform.

At step 310, the user can accept or decline the suggested social games, at which point the user can play the suggested contest 314 or choose their own contest 316. At step 318, the user wins or loses, and starts over.

On the server side, at step 312, if a user accepts the suggestion, the server will automatically calendar in contests. At step 320, the data is gathered at the contest steps, regardless of whether the user elects to play the suggest contest 314 or chooses their own contest 316, and sent to the operator and optionally, the merchant.

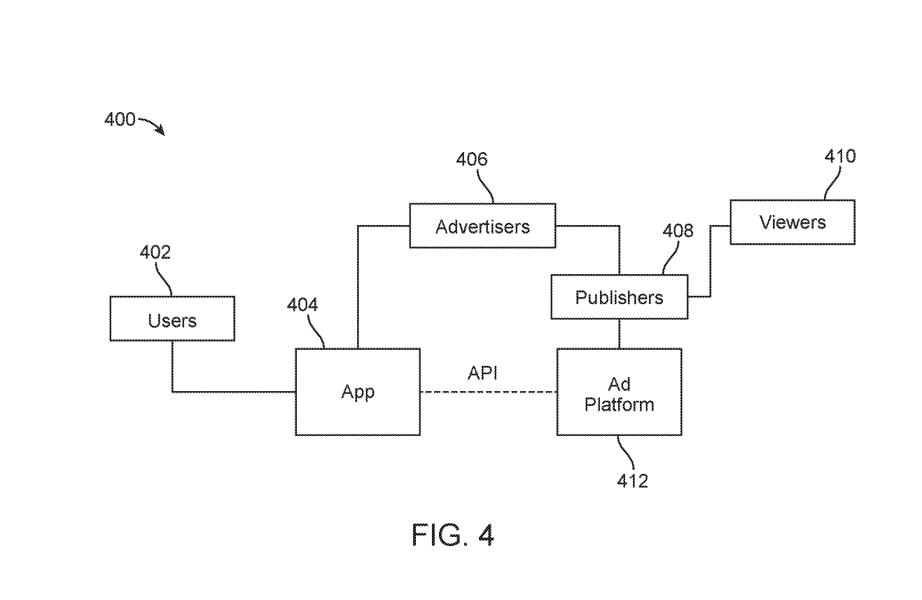

Referring now to FIG. 4, a block diagram showing an embodiment of the system is shown at 400. This system allows for communication between the platform and a partner site such that a partner can use the platform on its own website or mobile application via application program interface (API). As shown, a user 402 may be in communication with the platform via mobile app 404, and an API communicates with an ad platform 412. A publisher 408 is in communication with their ad platform 412, and an advertiser 406, such that a viewer 410 can view the advertisement. In other words, in addition to the native iOS/Android version of the platform, this functionality will allow the system to recreate the engagement advertising sequences on a partner publisher's home environment effectively serving platform ads (interactive, incentive driven, competitive) outside of the standalone mobile application.

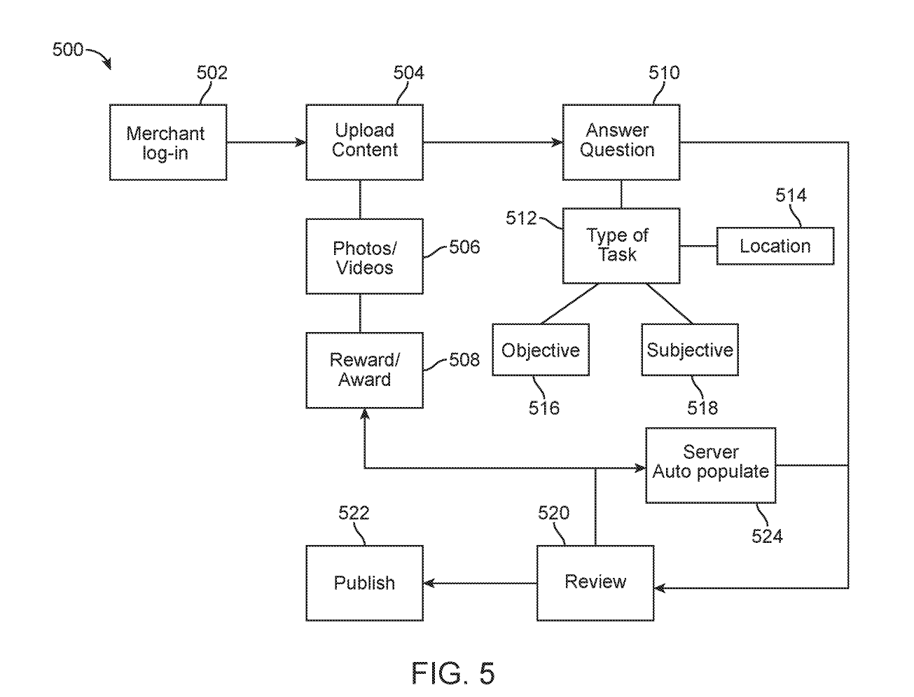

Referring now to FIG. 5, a flow chart showing a method for a merchant to build their own advertising campaign using the tool is shown generally at 500. In this embodiment, the merchant logs into their account at step 502 using a GUI. The merchant will then be prompted by the server to upload content, step 504. The content may include any type of media, such as photos and videos 506, and also what the prize, reward or award 508 will be. At step 510 the server will prompt the merchant with a set of questions based on the upload content. The questions may comprise the type of task 512 the merchant would like the user to complete. The task may be objective 516, for example, a quiz directly related to or correlated with the brand the merchant owns or represents. The task may also be subjective 518 such as a sweepstakes for an offer for a reward to share a link on a social media page, as an example. Once information is gathered, the server may auto-populate a campaign 524, which in some embodiments, are white labeled. At step 520, the merchant can review the campaign, and the tasks and games it has set up and if sufficient, can publish to the mobile app at step 522. If the merchant is not satisfied, the merchant will be sent back to step 504 to upload additional or different content, reset contest questions, and the like.

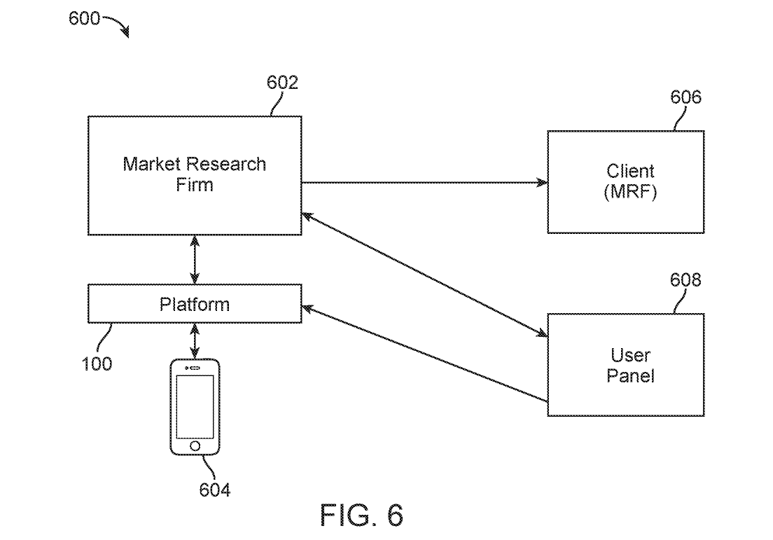

Referring now to FIG. 6, a block diagram showing a platform 100 used in accordance with embodiments of the present invention is shown generally at 600. In this particular embodiment, the platform 100 is in communication with the client 604 and the market research firm 602 (MRF). In this exemplary embodiment, the MRF 602 may white label and promotes the campaigns of platform 100 to its user panel 608. User panel 608 is in communication with the platform and uses the networked system as it would in FIGS. 1-5. The enhanced data gleaned from the user panels 608 can then be sold to MRF client 606.

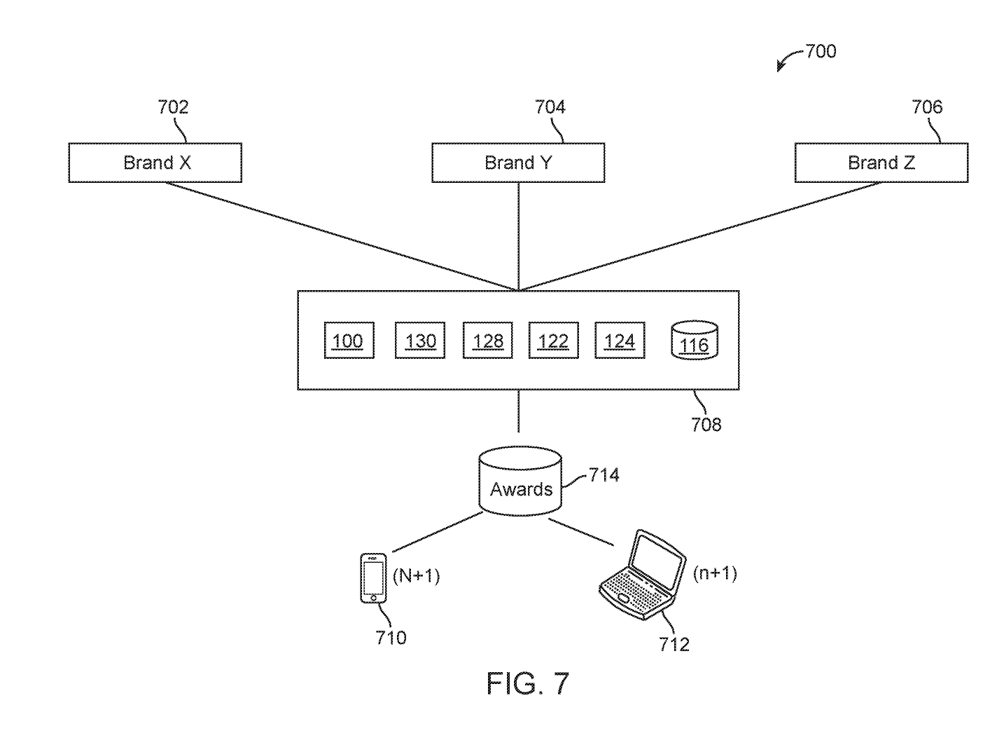

Referring now to FIG. 7, a loyalty and reward block diagram is shown generally 700. Brand X 702, Brand Y 704 and Brand Z 706 are three examples of brands that maybe chosen by a user. The platform 100 and the server 708 either have games or competitions loaded that correlate with each of the brands or the merchants associated with each of the brands, formulate a game or task for the user to play. Once the user, who is represented by smart phone 710 and computer 712, chooses a particular task to perform or game to play that is associated with any of the brands listed, the user will accrue points at database 714. The database will store the users points to be redeemed at a later time. In this way, users can elect to interact with multiple brands across the network and receive points that can be redeemed through the platform 100 with any of the brands associated with the network. In this way, the platform 100 acts as a type of “frequent flyer aggregator” to reward users for their participation and for their loyalty. In return the merchant receives not only monetary value but hyper-heightened brand awareness based on the gamification and engagement model provided by the platform 100 via server 708.

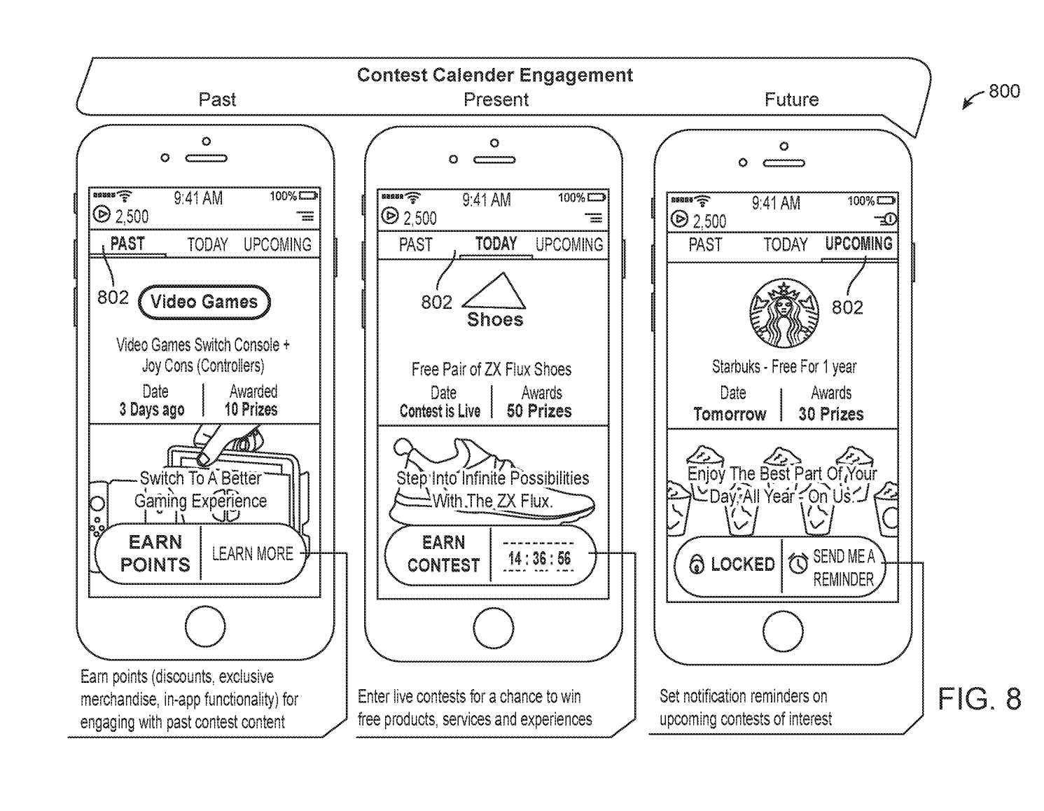

Referring now to FIG. 8, three mobile application GUIs are shown generally at 800. The GUIs 800 show an online social gaming platform in which user can win prizes based on social competition, utilize tasks to earn rewards and play games of his or her choice, in accordance with embodiments of the present invention.

Initially, a user must set up an account, and provide certain details to allow the system to provide suggestions based on the user profile. User profiles may comprise picture, areas of interests, age, gender, location, social networks and the like.

As shown in this exemplary embodiment, the entry navigation tab 802 displays to a user when his or her next challenge starts. In this exemplary embodiment, the prizes are a gaming system, sneakers and a gift card. In optional embodiments the prizes may other retail goods and the tasks may vary according to the prize. The navigation tabs allow the users to enter and view tasks that they must complete to win a particular prize.

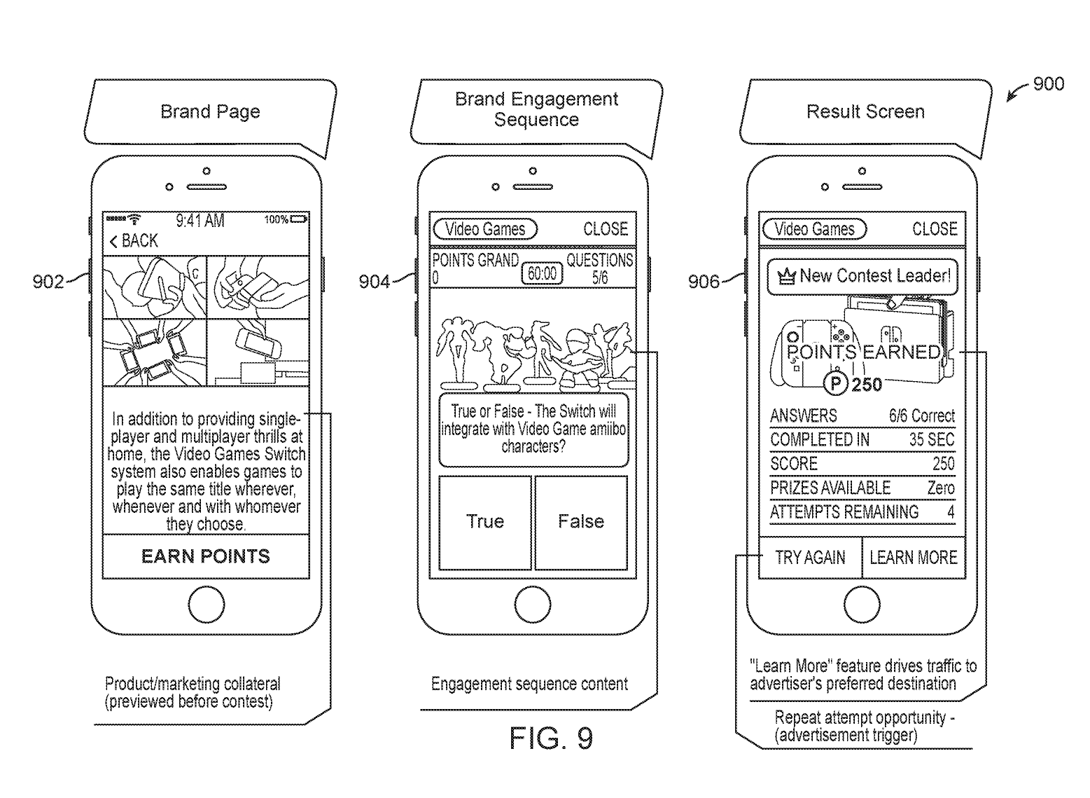

Referring now to FIG. 9, three mobile application GUIs are shown generally at 900. The GUIs 900 show an online social gaming platform in which user can win prizes based on social competition, utilize tasks to earn rewards and play games of his or her choice, in accordance with embodiments of the present invention.

In this exemplary embodiment, a brand page is shown first at 902. Then, the game or brand sequence engagement begins at 904, which is in this case, an objective quiz that cab be placed against other users to earn a prize or on ones own to earn points. The results page 906 shows the amount of points the user has earned for completing the task. The users, in these tasks, will be competing against the group of users who have also elected to attempt to win this prize. Importantly, users are grouped according to entry, and once the task begins, the system is configured to find the winner or winners of the task, and allow those winners to move on to the next tasks, or optionally, simply award the overall winner the prize. System transparency is important, and thus, users will be able to learn which other users are earning rewards and prizes.

It is also important to note that during each task, the merchant and operator is receiving valuable market data, enriches/extends brand engagement for advertisers, justifies higher advertising rate.

In exemplary embodiments of the present invention, user retention is increased due to interactive contests. In this exemplary embodiment, the platform is run on a smartphone, and is downloadable at an app store. As shown, the tasks are directed towards the prize itself. Consequently, the merchant not only receives advertising space due to the prize being awarded, but also teaches the users more about the product through the task at hand.

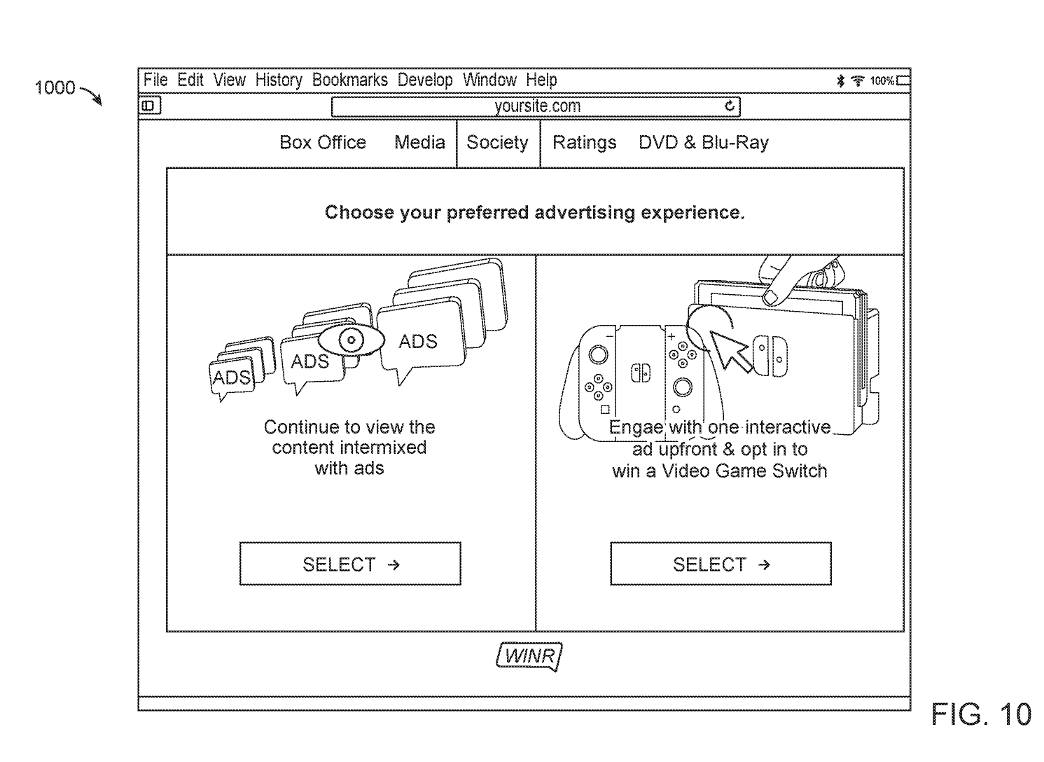

Referring now to FIG. 10, a GUI in the form of a webpage that allows a user to choose his or her advertising experience, is shown generally at 1000. In an exemplary embodiment a video watching service such as YouTube® or Hulu® requires the user to watch certain advertisements prior to or during the viewing experience. The platform of the present invention can be overlaid such that a user can't engage with one interactive advertisement upfront and be opted in to win a prize or incentive that could be awarded by their competitive performance (accuracy & speed) or via a sweepstakes type method as well as be able to then avoid disparate ads during the video presentation. In order to have the capacity to claim the potential incentive, the user may be required to create or use an existing account with either the host content provider (publisher), or the invention owner/network.

Referring now to FIG. 11, a block diagram showing an industry value chain utilizing the platform is shown generally at 1100. In this embodiment, the client 1102 is in communication with an advertising agency 1104 (i.e. content creator). The advertising agency 1104 may create and produce content for the client which resides on the platform. The advertising agency 1104 may be in communication with an agency trading desk 1104 (ATD), which is a massive media buyer and re-seller, and further utilize a Demand-Side Platform (DSP) 1108 to manage and optimize ad campaigns. In embodiments, ATDs work in combination with DSPs. Ad agency 1104 marketing specialists make use of programmatic advertising obtained through ATDs and optimize results using DSPs, especially when there is the need for re-targeting and building ad value using the platform, in this case.

The DSP 1108 is in communication with ad exchange 1110 to facilitates the buying and selling of the gamified media advertising inventory completed by the advertising agencies for use with the platform. Websites 1112 can utilize the ads with website traffic brokers 1114 to leverage the generated gamified ads on the platform.

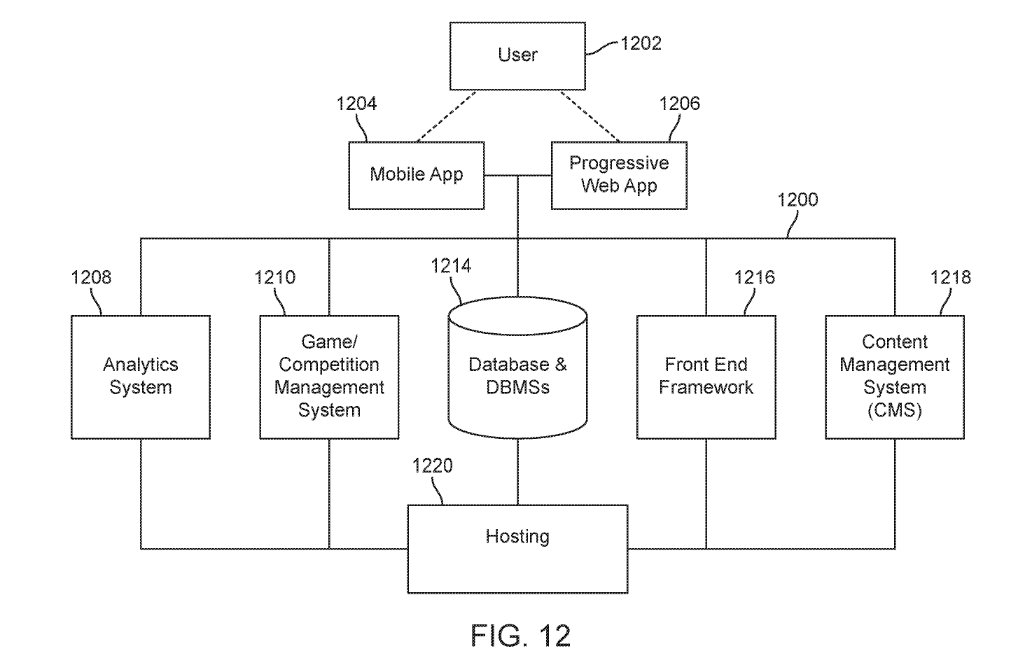

With reference now to FIG. 12 a block diagram in accordance with the embodiment of the present invention is shown generally at 1200. The platform as shown can be a Mobile app 1204 a progressive web app 1206. The user can interact with either or both. The mobile app 1204 or the progressive web at 1206 is in communication with analytics system 1208, game competition management system 1210, database 1214, front end framework or GUI 1216 and content management system 1218. A hosting service such as Amazon® AWS 1220 may operate as a cloud computing service for communication between components and users. Each of the analytics system 1208, game competition management system 1210, database 1214, front end framework or GUI 1216 and content management system 1218 function like their analogous components specified in the previous FIGS.

Content management system 1218 may comprise, for example, a content management application (CMA) configured as a front-end user interface that allows a user, to add, modify, and remove content from a website without the intervention of a webmaster. It may also comprise a content delivery application (CDA) compiles that information and updates the website, or a digital asset management system configured to manage and publish media.

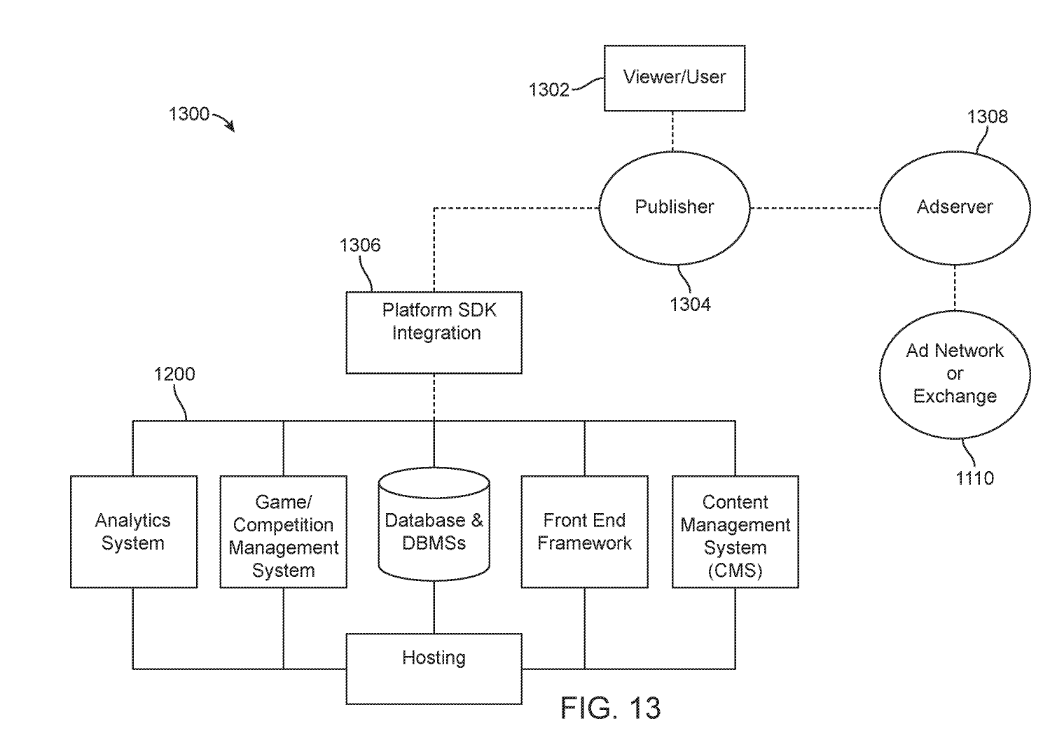

Referring now to FIG. 13, is block diagram illustrating the platform 1200 integrated with a partner system accordance with embodiments of the present invention shown generally at 1300. In this embodiment, the platform is provided via integration or software development kit (SDK) 1306 publishers to be able to display the platforms gamified ad format to viewers and users 1302. A publisher 1304 may interact with external participants (ad servers, exchanges and networks) to determine what branded ad content (in the ad format) served to a user based on information about the user that the publisher 1304 has. The publisher is in communication with ad server 1308 which places the ads on the web or mobile application. The ad exchange 1110 is in communication with the ad server in this embodiment.

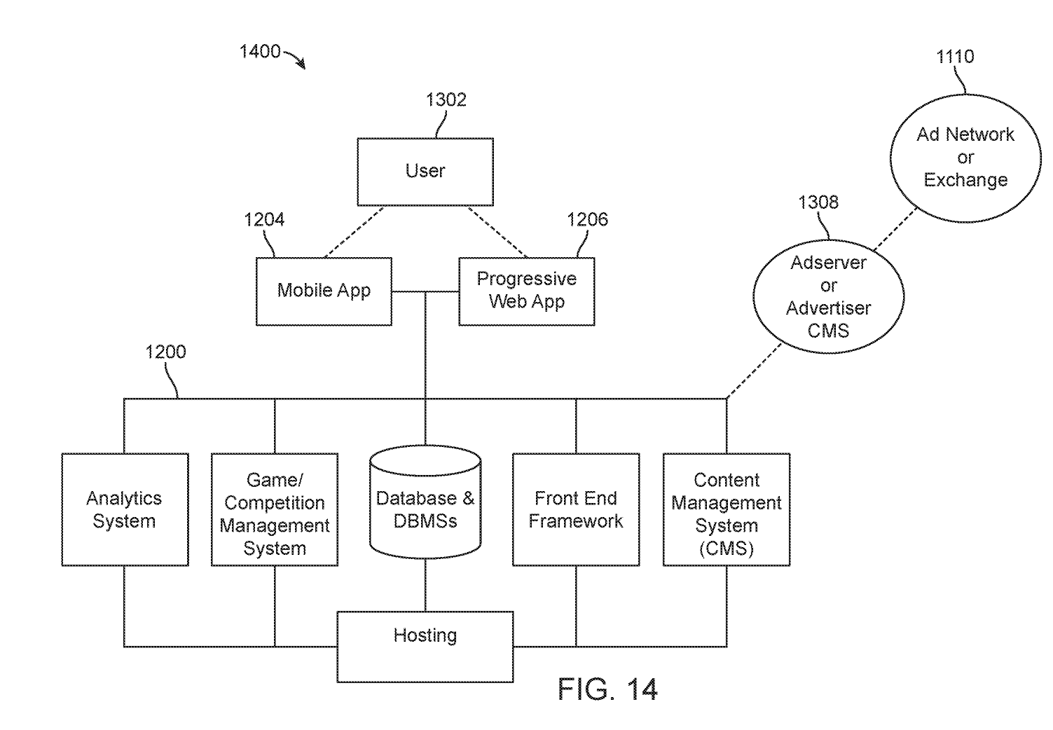

Referring now to FIG. 14, a block diagram illustrating the platform of FIG. 13, except that the ad server and ad network is in communication with the platform 1200 without the publisher 1304. In this embodiment, the platform 1200 is interacting with external participants, such as ad servers 1308, exchanges and networks 1310 to determine what branded content is available to a user 1302.

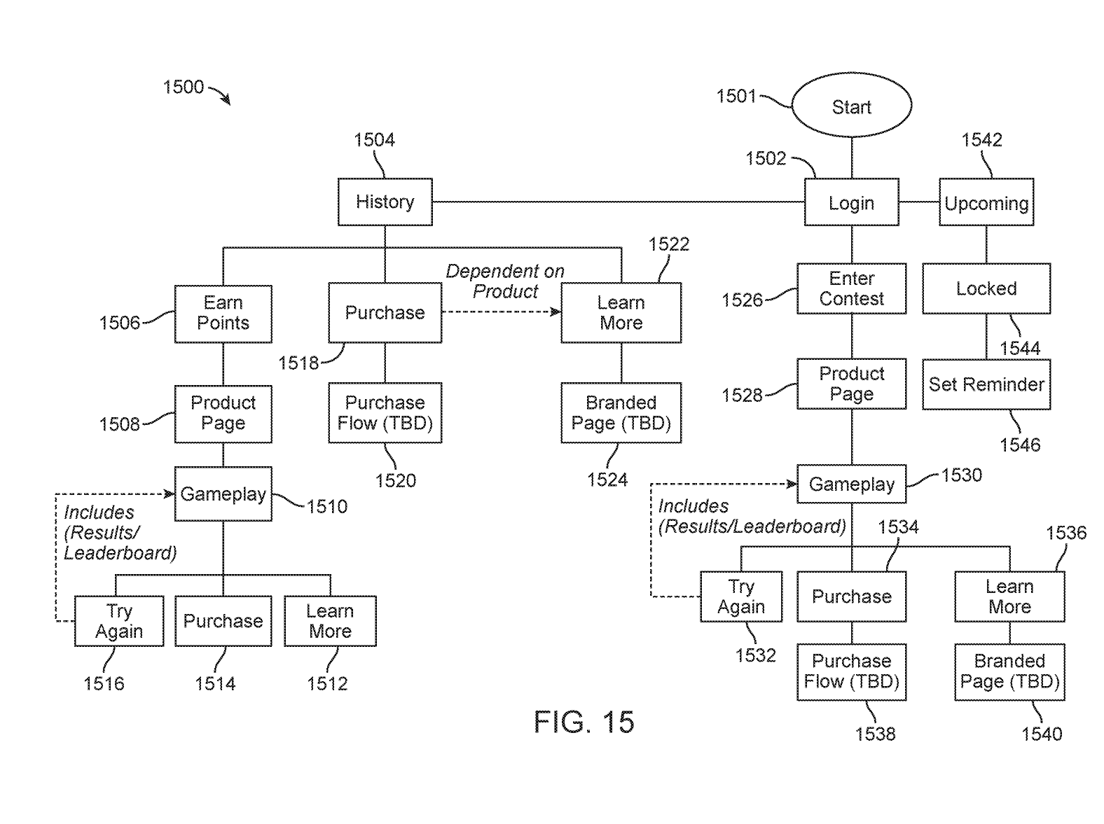

Referring now to FIG. 15 a block diagram flow chart showing the flow of the platform for gamification of ads is shown generally at 1500. At 1501, the user begins use of the platform and logs in at 1502. At block 1504, an exemplary history maybe shown. As an example of an in-platform option, at 1506, a user can complete tasks to earn points. The task maybe correlated with specific product for specific brand. There may be a prompt at 1508 for the user to go to a product page of his or her choosing and play a gamified add at block 1510. Based on the outcome of the gamified ad a user can try again at block 1516, make a purchase at lot 1514 or learn more about the particular brand that 1512. There may be a link off to a brand page in which a user can use reward points to make a purchase, or use currency to purchase a product.

Optionally from step 1504 username go directly to the purchase page block 1518 at which point the purchase flow block 1520 begins. Optionally the user may go directly to learn more page 1522 which is branded page at block 1524. The branded page may allow the consumer or user to interact with a brand directly using the platform as a conduit. The analytics gleaned from the platform will target certain users and certain brand for connection directly. Reward points can be used to make purchases through the platform of the specified branded products.

Optionally, after login at 1502, the user may enter a contest at block 1526. The user has an option of to go a product page block 1528. The gameplay block 1530 will be based around or correlated to that product. The task maybe correlated with specific product for specific brand. There may be a prompt at 1508 for the user to go to a product page of his or her choosing and play a gamified add at block 1510. Based on the outcome of the gamified ad a user can try again at block 1532, make a purchase at lot 1536 or learn more about the particular brand that 1540. There may be a link off to a brand page in which a user can use reward points to make a purchase, or use currency to purchase a product.

Optionally, after logging in the user can look it upcoming contest at lot 1542. The contests will be locked at 1544 until the contest is open for gaming. The user can set a reminder at block 1546 so that he or she gets notified of the upcoming contest correlated with the brand of their choosing.

While the present invention has been described in connection with what are presently considered to be the most practical and preferred embodiments, it is to be understood that the present invention is not limited to these herein disclosed embodiments. Rather, the present invention is intended to cover all of the various modifications and equivalent arrangements included within the spirit and scope of the appended claims.

Although specific features of various embodiments of the invention may be shown in some drawings and not in others, this is for convenience only. In accordance with the principles of the invention, the feature(s) of one drawing may be combined with any or all of the features in any of the other drawings. The words “including”, “comprising”, “having”, and “with” as used herein are to be interpreted broadly and comprehensively and are not limited to any physical interconnection. Moreover, any embodiments disclosed herein are not to be interpreted as the only possible embodiments. Rather, modifications and other embodiments are intended to be included within the scope of the appended claims.

We claim:

1. A system embodied on a computer readable storage medium for enhancing brand awareness, collecting data, or both, the system comprising:
a content management system (CMS) in communication with a memory and configured to identify a brand of a plurality of brands and manage generated content;
a task engine in communication with the CMS, the task engine configured to generate content, wherein the content comprises a plurality of gamified advertisements that are correlated to the brand, wherein a user interacts directly with the gamified advertisements;
an action engine in communication with the task engine and configured to monitor user action and behavior, capture analytics as outputs, or both; and
a rewards module in communication with the memory and configured to track user rewards based on achievement in the plurality of gamified advertisements correlated to the plurality of brands.

2. The system of claim 1, wherein the action engine automatically adjusts, via deep learning algorithm, which of the gamified advertisements is selected based on the user action and behavior, the captured analytics, or both.

3. The system of claim 1, wherein the action engine is further configured to compare preloaded key performance indicators with a user's performance to:
assess a marketing strategy of the brand;
receive a preference input from the user;
educate the user about the brand;
increase user engagement with the gamified advertisement; and
execute specific predetermined content marketing.

4. The system of claim 1, further comprising a graphical user interface (GUI) in communication with the memory and a server array, the GUI configured to allow a user to select the gamified advertisement from the plurality of gamified advertisment that are correlated with the brand of the plurality of brands based on the reward the user prefers to receive.

5. The system of claim 4, further comprising:
an elastic load balancer in communication with the server array;
a varnish pool in communication with the server array;
wherein the GUI is configured to receive tactile response from the user based on in-game activity, and output a signal to the elastic load balancer, wherein the signal is passed to the varnish pool to increase the speed of which the tactile response is received by the server array thereby increasing the fairness of the gamified advertisment.

6. A system embodied on a computer readable storage medium for providing an interactive user experience configured to optimize brand awareness collect data, or both, the system comprising:
a content management system (CMS) in communication with a memory and configured to receive media from an content creator;
a task engine configured to retrieve the media, the media being selectable and correlated to a brand;
wherein the task engine is further configured to communicate with an agency trading desk (ATD) and a demand-side platform (DSP) to manage and optimize the media, wherein the media is a gamified ad campaigns, and wherein the media is retrievable by the ATD and DSP.

7. The system of claim 6, wherein the CMS configured as a front-end user interface that allows a user, merchant, or the content creator to add, modify, and remove the media from the task engine.

8. The system of claim 6, wherein the CMS is integrated into an existing system using an application program interface or software development kit (SDK).

9. The system of claim 6, further comprising an action engine in communication with a memory, the action engine configured to:
monitor user action and behavior; and
capture analytics and send the analytics as outputs to the user or merchant.

10. The system of claim 6, further comprising a rewards module in communication with the memory, the rewards configured to track user rewards over multiple tasks.

11. The system of claim 6, wherein the computer product code is a mobile application downloadable onto a smart device.

12. A computer implemented method for enhancing brand awareness, collecting data, or both, the method comprising:
generating a plurality of tasks correlated to a plurality of brands, wherein the tasks are gamified advertisements;
receiving, from a client device, an input requesting to perform a task of the plurality of tasks;
displaying, on the client device, the requested task;
receiving outputs from the client device at the server, wherein the outputs are a user action;
capturing the actions and converting the actions into analytics.
tracking user rewards based on the actions in the plurality of gamified advertisements correlated to the plurality of brands.

13. The method of claim 12, further comprising automatically adjusting, via deep learning algorithm, which gamified advertisement is selected based on the user action and behavior, the captured analytics, or both.

14. The method of claim 12, further comprising comparing key performance indicators with the analytics to:
assess a marketing strategy of the plurality of brands;
receive a preference input from the user;
educate the user about the plurality of brand;
increase user engagement; and
execute content marketing.

15. The method of claim 12, wherein the outputs from the user are a tactical response, and once received, the method further comprises:
sending the response to an elastic load balancer in communication with a server array;
sending the output to a varnish pool in communication with the server array to increase the speed the outputs reach the server thereby increasing the fairness of the task.

16. The method of claim 12, further comprising receiving a request from a merchant to allow the merchant to select and load the task.

17. The method of claim 12, further comprising locating the user and the merchant such that the tasks are geo-specific based on a location of the merchant, user or both.

18. The method of claim 12, further comprising communicating with an agency trading desk (ATD) and a demand-side platform (DSP) to manage and optimize the media, and wherein the media is retrievable by the ATD and DSP.

19. The method of claim 12, further comprising modifying, adding or removing the task using a CMS.

20. The method of claim 12, further comprising reporting the analytics to an operator, merchant or both automatically at predetermined intervals.
